(19) United States
(12) Patent Application Publication
(10) Pub. No.: US 2008/0058021 A1
(43) Pub. Date: Mar. 6, 2008

(54) PANEL OF A HANDPHONE

(76) Inventor: Chi-Tsai Chang, Taichung City (TW)

Correspondence Address: LEONG C LEI, PMB # 1008, 1867 YGNACIO VALLEY ROAD, WALNUT CREEK, CA, 94598, US

(21) Appl. No.: 11/468,778

(22) Filed: Aug. 31, 2006

(51) Int. Cl. H04M 1/00

(52) U.S. Cl. 455/566

(57) ABSTRACT

A panel of a handphone is disclosed. The panel is characterized in that the keying pads for controlling are positioned at the upper section of the body of the phone, and the lower portion of the body is the positioned of the displaying screen, thereby in dialing, the palm of the user holds the body of the handphone, ensuring safe holding of the phone.

### BACKGROUND OF THE INVENTION

(a) Technical Field of the Invention

The present invention relates to a panel, and in particular, a panel used in handphone allowing convenient control in dialing.

(b) Description of the Prior Art

FIGS. 3 and 4 show a conventional front panel of handphone. The body 20 of the handphone has a display 21 is located on he upper portion of the handphone, and the key pads 22 for controlling in dialing are positioned at the lower portion of the handphone. In these conventional panel, in dialing numbers of the key pads 22, the body 20 of the handphone is pushed upward of the palm if dialing is to be done with one hand. If the palm is small to hold the handphone, the handphone may be dropped occasionally. In particular, recent handphone has a large LCD screen. In additional, the reading on the screen may not be easily read as a result of reflection in a particular angle. Accordingly, it is an object of the present invention to provide a panel of a handphone which facilitates single-handed dialing and provides clearer reading from the screen.

### SUMMARY OF THE INVENTION

The primary purpose of the present invention is to provide the keying pads for controlling are positioned at the upper section of the body of the phone, and the lower portion of the body is the positioned of the displaying screen, thereby in dialing, the palm of the user holds the body of the handphone, ensuring safe holding of the phone.

Yet still another object of the present invention to provide a panel of a handphone, wherein the lower section of the keying pad is an opening corresponding to the size of the displaying screen.

Still a further object of the present invention is to provide a panel of a handphone, wherein the upper section of the body is provided with rows of slots for the mounting of the keying pad.

Still yet another object of the present invention is to provide a panel of a handphone, wherein the keys on the keying pad is either protruded, flat or centrally convex shape.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a handphone of the present invention held in one hand.

FIG. 2 is a schematic view showing the dialing of the key pads of the handphone in accordance with the present invention.

FIG. 3 is a schematic view showing a handphone with conventional panel held in the hand of the user.

FIG. 4 is a schematic view showing the dialing of the key pads of the handphone with conventional displaying screen.

### DETAILED DESCRIPTION OF THE PREFERRED EMBODIMENTS

The following descriptions are of exemplary embodiments only, and are not intended to limit the scope, applicability or configuration of the invention in any way. Rather,the following description provides a convenient illustration for implementing exemplary embodiments of the invention. Various changes to the described embodiments may be made in the function and arrangement of the elements described without departing from the scope of the invention as set forth in the appended claims.

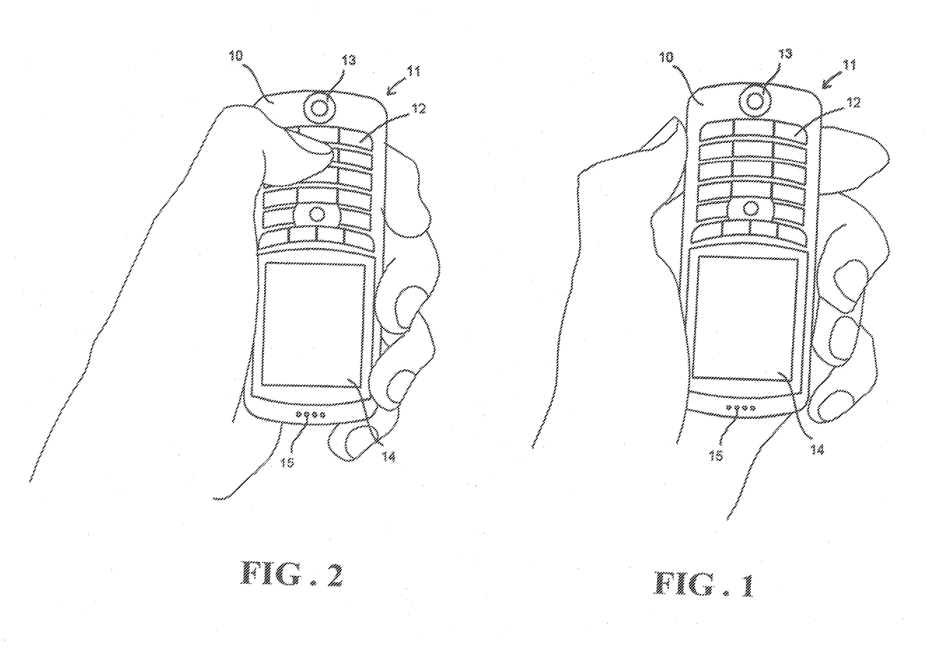

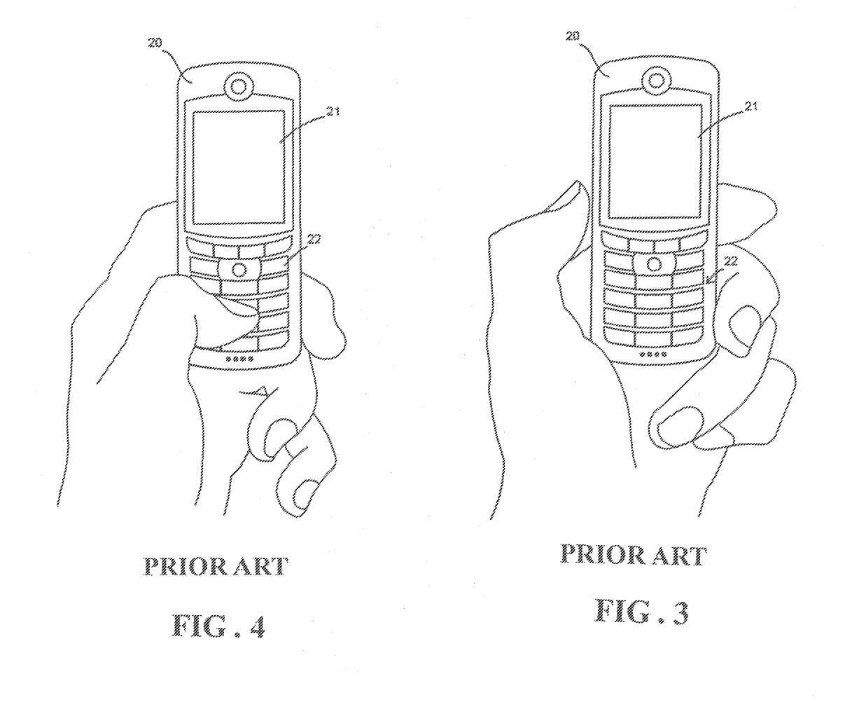

Referring to FIGS. 1 and 2, there is shown a conventional handphone wherein the displaying screen 14 is positioned at the lower portion of the handphone body 10 and the keying pads 11 is positioned at the lower portion of the handphone body 10.

In accordance with the present invention, the keys 12 is either protruded or flat or a slight convex shape. The key pads 12 are arranged on the upper portion of the handphone body 10 and the phone receiving device 13 is positioned at the top edge of the phone body 10. The lower edge of the key pads 11 is the displaying screen 14. A transmitting device 15 is positioned at the bottom portion of the handphone.

The displaying screen 14 is located at the lower section of the body 10 and the keying pads 11 for dialing are positioned at the upper portion of the displaying screen 14. The advantages of such arrangement of the panel is that the handphone can easily be held within the palm of one hand. The body of the handphone is positioned within the hand and the holding of the handphone is secured, in particular, the handphone facilitates dialing. As the keying pads 11 are located at the upper portion, the entire body 10 is held within the center of the palm and the fingers of the hand could easily and comfortably control the keying pads 11. The displaying screen 14 is positioned at the lower portion of the handphone body 10, the text on the displaying screen 14 is hidden, and any incoming calls will only be seen by the user. The entire body 10 of the handphone is secured held and will not easily drop accidentally.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operations can be made by those skilled in the art without departing in any way from the spirit of the present invention.

I claim:

1. A panel of a handphone comprising a body, keying pads and displaying screen, receiving device and transmitting device, characterized in that the keying pads for controlling are positioned at the upper section of the body of the phone, and the lower portion of the body is the positioned of the displaying screen, thereby in dialing, the palm of the user holds the body of the handphone, ensuring safe holding of the phone.

2. The panel of claim 1, wherein the lower section of the keying pad is an opening corresponding to the size of the displaying screen.

3. The panel of claim 1, wherein the upper section of the body is provided with rows of slots for the mounting of the keying pad.
